(19) United States
(12) Patent Application Publication
(10) Pub. No.: US 2010/0309218 A1
(43) Pub. Date: Dec. 9, 2010

(54) METHOD FOR COLOR CALIBRATION AND DEVICE USING THE SAME

(75) Inventors: Wei-Ting SUEN, Tainan County (TW); Ling-Hsiu HUANG, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX MEDIA SOLUTIONS, INC., Tainan County (TW)

(21) Appl. No.: 12/479,922

(22) Filed: Jun. 8, 2009

(51) Int. Cl. G09G 5/02

(52) U.S. Cl. 345/590

(57) ABSTRACT

A method for color calibration is provided. The method includes the steps of: providing an input color; obtaining luminance of the input color; determining a grey level of the input color according to luminance of the input color; determining a first calibration matrix and a second calibration matrix according to the grey level of the input color; generating a third calibration matrix according to the first calibration matrix, the second calibration matrix and the grey level of the input color; generating an output color according to the third calibration matrix and the input color.

### BACKGROUND OF THE INVENTION

1. Field of the Invention

The present invention relates to a method for color calibration and device using the same.

2. Description of the Related Art

To display images with optimum visual appearance, functions for adjusting color temperature are usually provided by monitors. The method for adjusting color temperature is called color calibration. The aim of color calibration is to measure or adjust the color response of a device (input or output) to establish a known relationship to a standard color space. Generally, colors displayed in monitors seen by us are calibrated. The determination of the optimum output color sometimes depends on a color space such as CIE RGB or CIE XYZ etc, users' preference. The relationship between input colors and output colors can be established with a calibration matrix Mₙ shown as follows:

$$[ \begin{matrix}{R}_{out} \\ {G}_{out} \\ {B}_{out}\end{matrix} ] = [ \begin{matrix}a {1}_{n} & b {1}_{n} & c {1}_{n} \\ a {2}_{n} & b {2}_{n} & c {2}_{n} \\ a {3}_{n} & b {3}_{n} & c {3}_{n}\end{matrix} ] \times [ \begin{matrix}{R}_{i n} \\ {G}_{i n} \\ {B}_{i n}\end{matrix} ]$$

, where n is the grey level of input colors. For a conventional calibration method, the 3*3 matrix is obtained after trial and error according to analyses from a measuring apparatus until an output color is preferred. Ideally, colors using a level of brightness or using a grey level are mapped to the calibration matrix Mₙ, for efficient calibration. Practically however calculating calibration matrices of all the grey levels separately is time-consuming and costly. Additionally, the calibration matrix is not suitable to calibrate colors at all grey levels. For example, a calibration matrix suitable for calibrating a bright gray level is not suitable for calibrating a dark gray level. In a worst case, color shift may occur.

To solve abovementioned problem, it is necessary to provide a method for calibrating colors with high speed and low cost according to different grey levels.

### BRIEF SUMMARY OF INVENTION

A detailed description is given in the following embodiments with reference to the accompanying drawings.

In one aspect, the present invention provides a method for color calibration. The method comprises the steps of: providing an input color; obtaining luminance of the input color; determining a grey level of the input color according to luminance of the input color; determining a first calibration matrix and a second calibration matrix according to the grey level of the input color; generating a third calibration matrix according to the first calibration matrix, the second calibration matrix and the grey level of the input color; generating an output color according to the third calibration matrix and the input color.

In another aspect, the present invention provides a color calibration device. The color calibration device comprises: a luminance generation unit for obtaining luminance of an input color, and determining a grey level of the input color according to luminance of the input color; a matrix unit for storing at least two calibration matrices; a matrix generation unit for generating a new calibration matrix according to the two calibration matrixes and the grey level of the input color; and a calibration unit for generating a output color according to the new calibration matrix and the input color.

The above-mentioned method for calibration and device thereof interpolates a plurality of calibration matrices to obtain better quality calibration matrices to calibrate colors at any grey level effectively.

### BRIEF DESCRIPTION OF DRAWINGS

The present invention can be more fully understood by reading the subsequent detailed description and examples with references made to the accompanying drawings, wherein:

FIG. 1 is a block diagram showing the structure of a color calibration device; and

FIG. 2 is a flow chart illustrating the method for color calibration according to an embodiment of the present invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

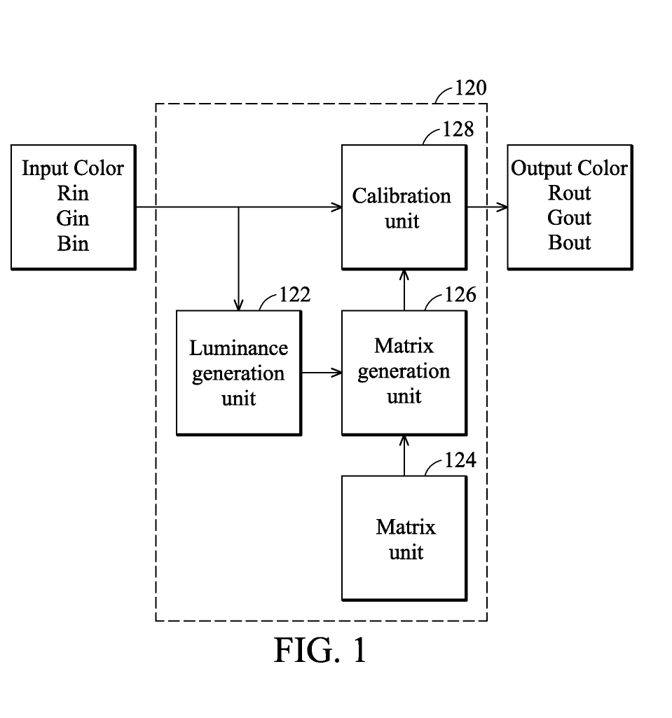

FIG. 1 is a block diagram showing the structure of a color calibration device. The color calibration device 120 is configured according to an input color from a color source for generating an output color. The input color is a mixture of colors from three primary colors: red, green and blue (RGB). The color calibration device 120 calibrates the input color to match the desired color temperature which is the output color.

In the embodiment, luminance of the input color is firstly determined by the luminance generation unit 122 in the color calibration device 120. The gray level of the input color is therefore defined according to the luminance of the input color. In general, there are at least two calibration matrices stored in the matrix unit 124. The matrices stored in the matrix unit 124 are obtained with a conventional method described in the description of the related art. Meanwhile, each calibration matrix usually corresponds to a grey level, the matrix symbol is written as Mₙ.

In the embodiment, when the grey level of the input color is 50, a regulated matrix responding to the grey level n=50 used to calibrate the input color is able to satisfy a required color quality, then the M₅₀ is selected to firstly be stored in the matrix unit 124 as a first calibration matrix. Other matrices are also selected in accordance with the same rule. For example when the grey level of the input color is 150, a regulated matrix responding to the grey level also satisfies a required color quality, then M₁₅₀ will be also selected to be stored in the matrix unit 124 as first as a second calibration matrix.

The matrix generation unit 126 is used to generate a required output calibration matrix by interpolating two calibration matrices according to the grey level of the input color. Following is a linear interpolation Formula known to those who skilled in the art:

$$f ( x ) = f ( {x}_{0} ) \frac{{x}_{1} - x}{{x}_{1} - {x}_{0}} + f ( {x}_{1} ) \frac{x - {x}_{0}}{{x}_{1} - {x}_{0}} \qquad ( 1 )$$

Therefore, the output calibration may be simply expressed as the following formula:

Mₒᵤₜₚᵤₜ=M_{first}X+M_{second}X′ (2)

where X and X′ are proportional to the grey level of the input color. Take an example, when the grey level of the input color is 75, the two calibration matrices used to derive the output calibration matrix M₇₅ are matrices M₅₀ and M₁₀₀ respectively. The output calibration matrix can be expressed as a Formula:

$${M}_{75} = {M}_{50} X + {M}_{100} {X}^{′} \\ Assume that {M}_{50} = [ \begin{matrix}a {1}_{50} & b {1}_{50} & c {1}_{50} \\ a {2}_{50} & b {2}_{50} & c {2}_{50} \\ a {3}_{5} 0 & b {3}_{50} & c {3}_{50}\end{matrix} ] , \\ and {M}_{100} = [ \begin{matrix}a {1}_{100} & b {1}_{100} & c {1}_{100} \\ a {2}_{100} & b {2}_{100} & c {2}_{100} \\ a {3}_{100} & b {3}_{100} & c {3}_{100}\end{matrix} ] . Then \qquad ( 3 )$$

the matrix M₇₅ can be calculated according to Formula (1) and (3).

$$\begin{matrix}{M}_{75} = [ \begin{matrix}a {1}_{50} & b {1}_{50} & c {1}_{50} \\ a {2}_{50} & b {2}_{50} & c {2}_{50} \\ a {3}_{5} 0 & b {3}_{50} & c {3}_{50}\end{matrix} ] \frac{100 - 75}{100 - 50} + [ \begin{matrix}a {1}_{100} & b {1}_{100} & c {1}_{100} \\ a {2}_{100} & b {2}_{100} & c {2}_{100} \\ a {3}_{100} & b {3}_{100} & c {3}_{100}\end{matrix} ] \frac{75 - 50}{100 - 50} \\ = \frac{1}{2} [ \begin{matrix}a {1}_{50} + a {1}_{100} & b {1}_{50} + b {1}_{100} & c {1}_{50} + c {1}_{100} \\ a {2}_{50} + a {2}_{100} & b {2}_{50} + b {2}_{100} & c {2}_{50} + c {2}_{100} \\ a {3}_{5} 0 + a {3}_{100} & b {3}_{50} + b {3}_{100} & c {3}_{50} + c {3}_{100}\end{matrix} ]\end{matrix}$$

The matrices with the corresponding grey levels are from 0-255 may be therefore calculated except for the grey level 50 and 100.

Finally, the calibration unit 128 calibrates the input color according to the output calibration matrix. The output color can be expressed as follows:

Rₒᵤₜ=Mₚᵤₜₚᵤₜ×Rᵢₙ (4)

Thus, Rₒᵤₜ=M₇₅×Rᵢₙ or written in matrix form:

$$[ \begin{matrix}{R}_{out} \\ {G}_{out} \\ {B}_{out}\end{matrix} ] = \frac{1}{2} [ \begin{matrix}a {1}_{50} + a {1}_{100} & b {1}_{50} + b {1}_{100} & c {1}_{50} + c {1}_{100} \\ a {2}_{50} + a {2}_{100} & b {2}_{50} + b {2}_{100} & c {2}_{50} + c {2}_{100} \\ a {3}_{5} 0 + a {3}_{100} & b {3}_{50} + b {3}_{100} & c {3}_{50} + c {3}_{100}\end{matrix} ] \times [ \begin{matrix}{R}_{i n} \\ {G}_{i n} \\ {B}_{i n}\end{matrix} ]$$

Thus, the output color best suited to be displayed in the grey level n=75 which is calibrated by the output calibration matrix is generated.

The output calibration matrices are derived with linear interpolation, which means that the output colors are calibrated linearly according to luminance of input colors. During practical application, visual characteristics of output colors are not necessarily linearly to the luminance of input colors. To improve the quality of colors or more precisely calibrate colors, the matrices stored in the matrix unit 124 in advance which are obtained from a conventional method must be increased. When more than two matrices are stored in the matrix unit 124, the rule for selecting the two proper calibration matrices to derive the output calibration matrix corresponding to a grey level of an input color is based on the two matrices with corresponding grey levels that are the closest grey levels to the grey level of the input color.

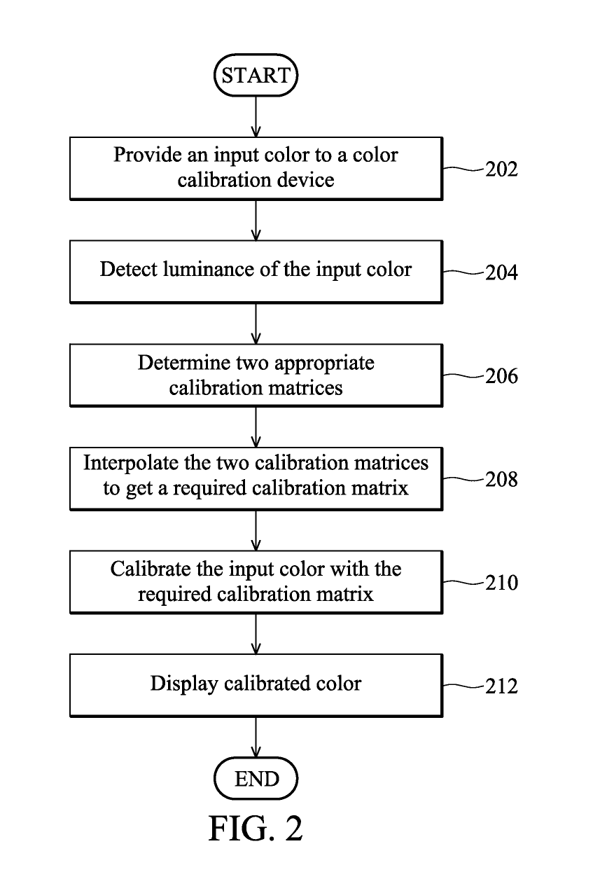

FIG. 2 is a flow chart illustrating the method for color calibration according to an embodiment of the present invention. At step 202, an input color is provided by a color source, and received by the color calibration device 120. The device 120 detects luminance of the input color at step 204 to determine a grey level of the input color. In the embodiment, at least two calibration matrices are stored in advance in the color calibration device 120. The at least two calibration matrices can usually be widely used to calibrate the input color for satisfying a required color quality. The at least two calibration are obtained from measurement and experimentation. At step 206, two appropriate calibration matrices are determined from the at least two matrices according to the grey level of the input. Each calibration matrices corresponds to a grey level. The calibration matrices with corresponding grey levels that are the closest grey levels to the grey level of the input color are selected to execute interpolation. The required calibration matrix is generated from interpolating the two calibration matrices at step 208. The color calibration device 120 uses the required calibration matrix to calibrate the input color at step 210. The calibrated color outputted from the color calibration device 120 is displayed in a screen at step 212.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for color calibration, comprising:
providing an input color;
obtaining luminance of the input color;
determining a grey level of the input color according to the luminance of the input color;
determining a first calibration matrix and a second calibration matrix according to the grey level of the input color;
generating an output calibration matrix according to the first calibration matrix, the second calibration matrix and the grey level of the input color; and
generating an output color according to the output calibration matrix and the input color.

2. The method as claimed in claim 1, wherein generating the output calibration matrix comprises linearly interpolating the first calibration matrix and the second calibration matrix.

3. The method as claimed in claim 1, wherein determining the first calibration matrix and the second calibration matrix comprises selecting the first calibration matrix corresponding to a first grey level and the second calibration matrix corresponding to a second grey level, wherein the first grey level and the second grey level are the closest grey levels to the grey level of the input color.

4. A color calibration device, comprising:
a luminance generation unit for obtaining luminance of an input color, and determining a grey level of the input color according to luminance of the input color;
a matrix unit for storing at least two calibration matrices;
a matrix generation unit for generating an output calibration matrix according to the two calibration matrices and the grey level of the input color; and
a calibration unit for generating an output color according to the output calibration matrix and the input color.
